(19) United States
(12) Patent Application Publication
(10) Pub. No.: US 2026/0213045 A1
(43) Pub. Date: Jul. 23, 2026

(54) SUPERCONDUCTIVE FILAMENT CORE COAXIAL CABLE

(71) Applicant: IQM FINLAND OY, Espoo (FI)

(72) Inventor: Matthew Sarsby, Espoo (FI)

(21) Appl. No.: 19/265,584

(22) Filed: Jul. 10, 2025

Related U.S. Application Data
(63) Continuation of application No. 19/220,951, filed on May 28, 2025.

(30) Foreign Application Priority Data
May 29, 2024 (FI) 20245687

(51) Int. Cl. H01B 11/18; H01B 1/02; H01B 12/10; H01B 13/016; H01B 13/06

(52) U.S. Cl. CPC H01B 11/1895; H01B 11/1808; H01B 12/10; H01B 13/0162; H01B 13/067; H01B 1/026

(57) ABSTRACT

The present invention relates to a coaxial cable having a superconductive filament core, a method of manufacturing such coaxial cable, a method of using one or more of such coaxial cable and a system comprising one or more of such coaxial cables. The coaxial cable comprises an inner conductor (or core); an outer conductor; and an insulator. The outer conductor is made of a first electroconductive material. The insulator is provided between the inner conductor and the outer conductor. The inner conductor comprises a filament and a mantle (or matrix). The filament is made of a second electroconductive material. The mantle is made of a third electroconductive material and the mantle surrounds the filament. The filament, in particular the second electroconductive material, comprises a superconductive material.

### CROSS-REFERENCE TO RELATED APPLICATIONS

This application claims the benefit of and priority to U.S. patent application Ser. No. 19/220,951, filed May 28, 2025, which claims the benefit of and priority to Finnish Patent Application No. 20245687, filed May 29, 2024, the entire contents of each of which are incorporated by reference herein.

### BACKGROUND

The present invention relates to a coaxial cable having a superconductive filament core, a method of manufacturing such coaxial cable and a method of using one or more of such coaxial cable.

### TECHNICAL FIELD

Quantum effects are used in novel applications. These applications are realized in cryogenic systems such as quantum sensing systems or quantum computing systems (quantum computers). In such cryogenic systems superconductive signal lines, in particular, super conductive coaxial cables are used for transmitting signals including a DC current component. A major concern in said cryogenic systems is Joule heating of the superconductive signal lines.

For example, for quantum computers quantum processing units comprising one or more qubits need to be provided. This is currently done via superconducting quantum processors. In such processor multiple transmission lines realised by means of multiple coaxial cables are connected in series to a signal generator. The coaxial cables comprise a superconductive inner conductor or core, an insulator and a superconductive outer conductor. Further, the coaxial cables are connected to one another and to the signal generator by means of connectors.

The coaxial cables are very expensive due to the high costs of the superconductive material the inner conductor and the outer conductor are made of. Further, special cost intensive and laboursome joining processes like gold plating have to be applied to join superconductive material of the coaxial cables with the connectors. Besides the high costs for the coaxial cables and joining processes, the joints between the coaxial cable and the connectors are error prone.

### DESCRIPTION OF THE INVENTION

It is the subject of the present invention to remove or at least alleviate the disadvantages and problems described above. Thereto a coaxial cable according to a first aspect of the present invention, which is the subject of independent claim 1, a method of manufacturing a coaxial cable according to a second aspect of the present invention, a method of using the coaxial cable according to a third aspect of the present invention and a system comprising the coaxial cable according to a fourth aspect of the present invention, which are the subject of the further independent claims, are provided. Refinements and further developments of the present invention are subject of the respective dependent claims.

The coaxial cable according to the first aspect of the present invention comprises an inner conductor (or core); an outer conductor; and an insulator. The outer conductor is made of a first electroconductive material. The insulator is provided between the inner conductor and the outer conductor. The inner conductor comprises a filament and a mantle (or matrix). The filament is made of a second electroconductive material. The mantle is made of a third electroconductive material and the mantle surrounds (or embeds) the filament. The filament, in particular the second electroconductive material, comprises a superconductive material.

The coaxial cable according to the first aspect of the present invention is a superconductive filament core coaxial cable. The inner conductor or core of the coaxial cable according to the first aspect of the present invention is a superconductive filament core.

The method of manufacturing a coaxial cable according to the second aspect of the present invention comprises the steps of providing a filament; surrounding the filament with a mantle, sheathing the inner conductor, and encasing the insulator with an outer conductor. In the step of providing a filament, a filament made of a second electroconductive material is provided. The second electroconductive material comprises a superconductive material. In the step of surrounding the filament with a mantle, the filament is surrounded with a mantle (or matrix) made of a third electroconductive material to form an inner conductor (or core). In the step of sheathing the inner conductor with an insulator, the inner conductor is sheathed with an insulator. In the step of encasing the insulator with an outer conductor, the insulator is encased with an outer conductor made of a first electroconductive material.

The method according to the second aspect of the present invention may in particular be a method of manufacturing the coaxial cable according to the first aspect of the present invention, i.e., the superconductive filament core coaxial cable.

In method according to the third aspect of the present invention one or more coaxial cables according to according to the first aspect of the present invention are used in a quantum device, in particular a quantum computer at the quantum processing unit (QPU) of the quantum computer. The coaxial cables are in particular used for providing transmission lines for providing signals to qubits of the QPU.

The system according to the fourth aspect of the present invention comprises one or more coaxial cables according to the first aspect of the present invention for providing transmission lines for providing signals to the qubits.

The coaxial cable according to the first aspect of the present invention and as manufactured according to the second aspect of the present invention and as used according to the third aspect of the present invention and as comprised by the system according to the fourth aspect of the present invention is a coaxial transmission line that is particularly suitable for signals comprising a DC current with higher frequency overlays. The coaxial cable further provides for a superconductive transmission line as required, e.g., for providing signals to qubits in quantum computing.

The filament of the inner conductor or core made of the second electroconductive material may be provided along the centreline of the coaxial cable.

The second electroconductive material comprises or, in particular, is a superconductive or superconducting material that provides for superconductivity below a specific temperature. Ther terms superconductive and superconducting are used synonymously regarding the present invention. The superconductive material may be any material that provides for superconductive properties, like a superconductive metal, ceramic, organic material, or heavily doped semiconductor that conducts electricity without resistance. In particular, the superconductive material may be a high temperature superconductive material or in other words a high temperature superconductor (HTS). Consequently, the filament made of the second electroconductive material provides for superconductivity when an adequate cooling is provided and, thus, can provide a transmission line suitable for use in cryogenic systems and quantum applications like quantum sensing systems or quantum computers.

The filament is surrounded with or embedded in the mantle or matrix made of the third electroconductive material. In particular, the filament may be surrounded with/embedded in the mantle/matrix such that the second electroconductive material (superconductive material) is circumferentially enclosed by the third electroconductive material (non-superconductive). The filament and the mantle/matrix may provide for a concentric structure of the inner conductor/core in the cross-sectional direction.

The third electroconductive material may be a common electroconductive material like a metal, alloy, semiconductor or the like that does not provide for superconductivity when cryogenically cooled (e.g., with liquid N₂ or liquid He). In other words, the third electroconductive material may be a “non-superconductive” material. Consequently, the mantle or matrix can be joined to a connector using common welding or soldering techniques.

The mantle or rather the inner conductor is sheathed or coated with the insulator. In particular, the insulator may circumferentially cover the inner conductor. The insulator and the inner conductor may form a concentric structure in the cross-sectional direction. In particular, the filament, the mantle and the insulator may form a concentric structure in the cross-sectional direction.

The insulator may be made of any dielectric material like synthetics or ceramics. The dielectric material may in particular comprise Polytetrafluorethylen (PTFE), Polyethylen (PE), Polyamide (PA), Perfluoroalkoxy (PFA) or the like.

The inner conductor may be in direct contact with the insulator. Alternatively, the inner conductor may not be in direct contact with the insulator and one or more additional layers may be provided between the inner conductor and the insulator.

The insulator is encased with the outer conductor made of the first electroconductive material. In particular, the outer conductor may circumferentially enclose the insulator. The insulator electrically and spatially separates the inner conductor from the outer conductor. The outer conductor and the insulator may form a concentric structure in the cross-sectional direction. In particular, the inner conductor, or rather the filament and the mantle, the insulator and the outer conductor may form a concentric structure in the cross-sectional direction.

The first electroconductive material may be a common electroconductive material like a metal, alloy, semiconductor or the like that does not provide for superconductivity when cooled with liquid Ni or liquid He. In other words, the first electroconductive material may be a “non-superconductive” material. Consequently, the outer conductor can be joined to a connector using common welding or soldering techniques.

The insulator may be in direct contact with the outer conductor. Alternatively, the insulator may not be in direct contact with the outer conductor and one or more additional layers may be provided between the insulator and the outer conductor.

The inner core or rather the superconductive filament core of the coaxial cable according to the present invention provides for superconductivity and can be used as a transmission line with minimal Joule heating. Thus, the coaxial cable according to the present invention is particularly suitable for use in cryogenic systems and quantum applications such as quantum sensing and quantum computing. Further, the coaxial cable according to the present invention is considerably less expensive than common superconductive coaxial cables since only a relatively small amount of superconductive material is necessary for providing the filament. The remaining electroconductive parts are made of much less expensive “non-superconductive” material. In addition, the coaxial cable according to the present invention can be more easily and more reliably joint to connectors, since common joining processes like welding or soldering can be utilised.

According to a refinement of the present invention, the first electroconductive material comprises Copper (Cu), Copper alloy (e.g., Copper-Nickel (Cupronickel, CuNi) or Phosphor Bronze), stainless steel, silver plated stainless steel or Tungsten (Wolfram, W) or a combination thereof.

According to a refinement of the present invention, the third electroconductive material comprises Copper (Cu), Copper alloy (e.g., Copper-Nickel (Cupronickel, CuNi) or Phosphor Bronze), stainless steel, silver plated stainless steel or Tungsten (Wolfram, W) or a combination thereof.

According to a refinement of the present invention, the first electroconductive material and the third electroconductive material are the same or different.

Providing the first electroconductive material and/or the third electroconductive material from Copper (Cu), Copper alloy, (silver plated) stainless steel or Tungsten (W) or a combination thereof leads to a particularly easy and reliable processability of and at the same time low price for the coaxial cable.

According to a refinement of the present invention, the filament comprises two or more layers of second electroconductive materials comprising superconductive materials.

The filament may comprise two or more concentrical layers of different second electroconductive materials comprising different superconductive materials. The layers may have alternatingly different or mutually different second electroconductive layers comprising different superconductive materials.

By using different second electroconductive materials for the filament the properties of the filament can be specifically fine-tuned.

According to a refinement of the present invention, the superconductive material comprises a Niobium alloy, in particular, Niobium-Titanium (NbTi), Niobium-Tantalum (NbTa), Niobium-Tin (Nb₃Sn), or a combination thereof.

Niobium alloys provide excellent superconductivity and good processability for pultrusion of the filament.

According to a refinement of the present invention, the diameter of the filament is between 1% and 95% of the diameter of the inner conductor.

Depending on the amperage of the electric current that is introduced to the filament the diameter of the filament can be selected to a suitable size without changing the overall diameter of the inner conductor. This provides for a high adaptability without having to change the layout of the respective system.

According to a refinement of the present invention, the coaxial cable may further comprise an outer insulator surrounding the outer conductor.

According to a further refinement of the present invention, the method may further comprise the step of jacketing the outer conductor with an outer insulator.

The outer conductor may be partially or fully jacketed or coated with the outer insulator. In particular, the outer insulator may circumferentially cover the outer conductor. The outer insulator and the outer conductor may form a concentric structure in the cross-sectional direction.

The outer insulator may be made of any dielectric material like synthetics or ceramics. The dielectric material may in particular comprise Polytetrafluorethylen (PTFE), Polyethylen (PE), Polyamide (PA), Perfluoroalkoxy (PFA) or the like.

The outer conductor may be in direct contact with the outer insulator. Alternatively, the outer conductor may not be in direct contact with the outer insulator and one or more additional layers may be provided between the outer conductor and the outer insulator.

The outer insulator provides for more safety from and protection of the outer conductor.

According to a refinement of the present invention, the inner conductor comprises only one filament surrounded by the mantle.

According to a further refinement of the present invention, in the step of providing a filament, only one filament is provided. Further in the step of surrounding the filament with a mantle, the only one filament is surrounded with the mantle.

The one filament is sufficient for providing the superconductivity needed for a transmission line suitable for use in applications that require signals including a DC current with higher frequency overlays, like quantum sensing or quantum computing.

Consequently, the coaxial cable having only one filament with superconductivity in the inner conductor provides for the best cost-value ratio for quantum applications.

According to a refinement of the present invention the inner conductor comprises a plurality of filaments surrounded by the mantle.

According to a further refinement of the present invention, in the step of providing a filament, a plurality of filaments is provided. Further, in the step of surrounding the filament with a mantle, the plurality of filaments is surrounded with the mantle.

The number of filaments, the (different) diameters of the filaments and the (different) materials of the filaments can be selected based on the respective requirements of the system in which the coaxial cable is to be used. Further, the plurality of filaments can be arranged in different ways along the cross-section of the inner conductor inside the mantle or matrix. For example, the filaments can be arranged in a circular, octagonal, hexagonal, rectangular or triangular shape with one or more central filaments and one or more surrounding rings, octagons, hexagons, rectangles or triangles of filaments.

The plurality of filaments in the inner conductor provides for maximal flexibility for different fields of application.

According to a refinement of the present invention, at least two filaments of the plurality of filaments are made of different second electroconductive materials comprising different superconductive materials.

By selecting different second electroconductive materials comprising different superconductive materials, the properties of the coaxial cable can be fine-tuned to the respective needs of the superior system.

### SHORT SUMMARY OF THE FIGURES

In the following preferred embodiments and configurations of the present invention are described in more detail with reference to the eclosed drawings to provide for a better understanding of the present invention. These embodiments and configurations are merely exemplary and are not to be construed as limiting to the scope of protection. Rather, the enclosed claims exclusively define the scope of protection.

FIG. 1 depicts a first exemplary embodiment of a coaxial cable according to the first aspect of the present invention.

FIGS. 2a and 2b depict a second exemplary embodiment of the coaxial cable according to the first aspect of the present invention.

FIG. 3 depicts a flowchart showing an exemplary method of manufacturing a coaxial cable according to the second aspect of the present invention.

### DETAILED DESCRIPTION OF THE FIGURES

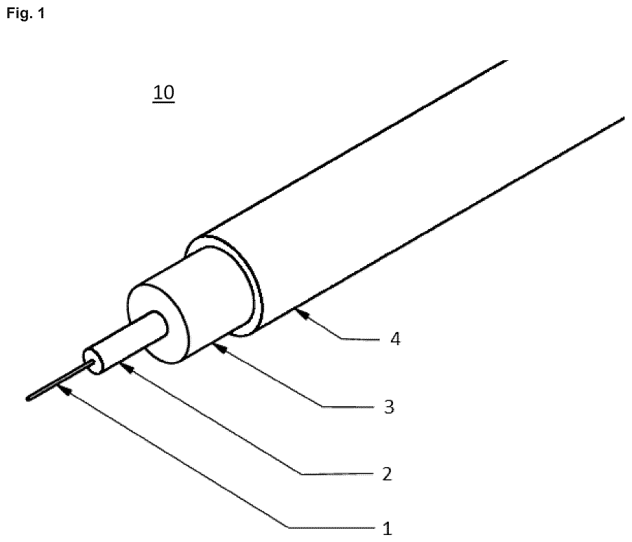

In FIG. 1 a coaxial cable 10, in particular, a superconductive filament core coaxial cable is depicted. The different parts of the coaxial cable 10 are depicted partially “un-covered” or “stripped”. This is however only for better presentability of the respective parts of the coaxial cable 10 and does not represent the default configuration.

The coaxial cable 10 comprises an inner conductor, an insulator 3 and an outer conductor 4. The inner conductor comprises a filament 1 and a mantle or matrix 2. The filament 1 and the mantle 2 of the inner conductor are arranged in a concentrical structure in the direction of the cross-section of the inner conductor. The inner conductor, i.e., the filament 1 and the mantle 2, and the insulator 3 and the outer conductor 4 are arranged in a concentrical structure in the direction of the cross-section of the coaxial-cable 10.

Along the centreline of the coaxial cable 10 the filament 1 is provided. The filament 1 is made of a second electroconductive material which comprises or, in particular, is a superconductive material. The filament 1 provides for the superconductivity that is necessary for providing a transmission line suitable for use in cryogenic systems or quantum applications, in particular, in a quantum computer.

The filament 1 is partially or fully surrounded or embedded in the mantle 2. The mantle 2 is made of a third electroconductive material which is a “non-superconductive” material, i.e. a common electroconductive material like a metal, alloy, semiconductor or the like that does not provide for superconductivity when cryogenically cooled. Optionally, the mantle 2 can be made of more than one third electroconductive material, in other words, different third electroconductive materials. The mantle 2 can be easily joint with a connector by welding or soldering.

The mantle 2 or rather the inner conductor is sheathed or coated with the insulator 3. The insulator 3 is made of a dielectric material. The inner conductor and the outer conductor 4 are spatially and electrically separated by the insulator 3.

The outer conductor 4 encloses the insulator 3 and is made of a first electroconductive material that is “non-superconductive”. The first electroconductive material and the third electroconductive material may be the same material or different materials. The outer conductor 4 can be easily joint with a connector by welding or soldering.

The coaxial cable 10 provides superconductivity, e.g. for providing a transmission line in a quantum processor of a quantum computer, with only a very small amount of superconductive material. Thus, the costs for the coaxial cable 10 are considerably lower compared to common superconductive coaxial cables. Further, compared to the laboursome and expensive special joining processes necessary for common superconductive cables (e.g., gold plating), the coaxial cable 10 can be more easily and more reliably joint with a connector by common joining processes like welding or soldering.

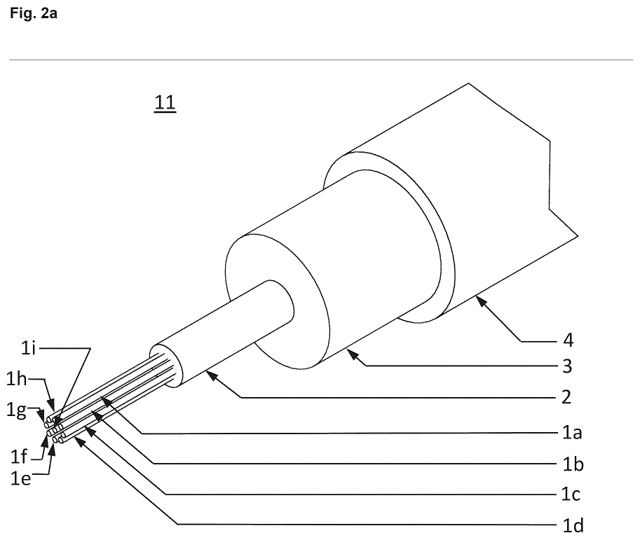

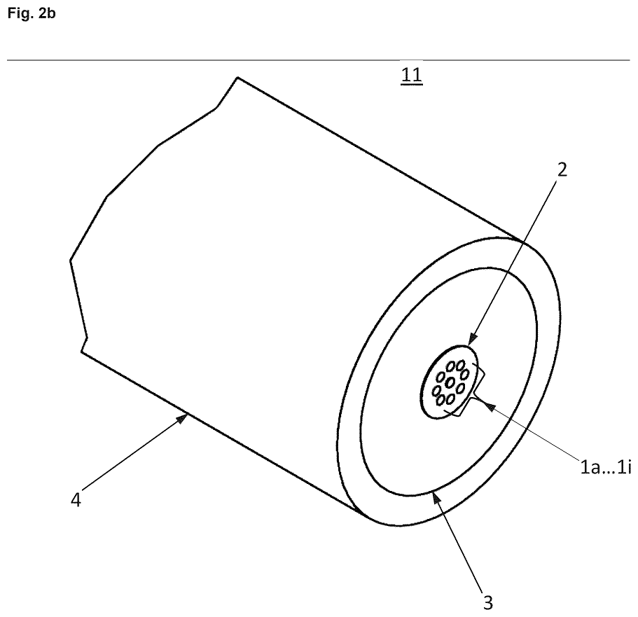

In FIGS. 2a and 2b a coaxial cable 11, in particular, a superconductive filament core coaxial cable is depicted. The coaxial cable 11 differs from the coaxial cable of FIG. 1 described above only in the structure of the inner conductor. Consequently, only the differences between the two coaxial cables are described in the following to avoid any redundant explanations. In FIG. 2a the different parts of the coaxial cable 11 are depicted partially “un-covered” or “stripped”. This is however only for better presentability of the respective parts of the coaxial cable 11 and does not represent the default configuration.

The coaxial cable 11 comprises an inner conductor, an insulator 3 and an outer conductor 4. The inner conductor comprises a plurality of filaments 1a . . . 1i and a mantle or matrix 2.

Here nine filaments 1a . . . 1i are provided in the inner conductor. This number of filaments is, however, only exemplary a plurality of less or more than nine filaments may be provided in the inner conductor. The filaments 1a . . . 1i and the mantle 2 of the inner conductor are arranged in a concentrical structure in the direction of the cross-section of the inner conductor. The nine filaments are arranged in a circular shape in the direction of the cross-section of the inner conductor, while one central filament 1i is surrounded by eight filaments 1a . . . 1h arranged along a circle. The inner conductor, i.e., the plurality of filaments 1a . . . 1i and the mantle 2, and the insulator 3 and the outer conductor 4 are arranged in a concentrical structure in the direction of the cross-section of the coaxial-cable 11.

The filaments 1a . . . 1i are made of a second electroconductive material which comprises or, in particular, is a superconductive material. Each filament may be of a different diameter and/or of a different second electroconductive material which comprises or, in particular, is a different superconductive material. The filaments 1a . . . 1i provide for the superconductivity that is necessary for providing a transmission line suitable for use in cryogenic systems and quantum applications like a quantum computer.

The plurality of filaments 1a . . . 1i is partially or fully surrounded or embedded in the mantle 2. The mantle 2 is made of a third electroconductive material which is a “non-superconductive” material. Optionally, the mantle 2 can be made of more than one third electroconductive material, in other words, different third electroconductive materials. The mantle 2 can be easily joint with a connector by welding or soldering.

The coaxial cable 11 provides for the same advantages as the coaxial cable of FIG. 1 described above and additionally for better stability of the superconducting state in high magnetic field environments and higher stability with larger currents.

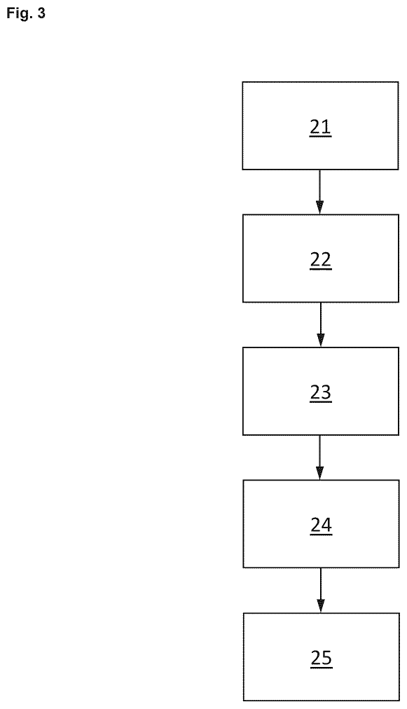

In FIG. 3 a flowchart showing a method of manufacturing a coaxial cable is depicted. The method comprises the steps of providing 21 a filament, surrounding 22 the filament with a mantle, sheathing 23 the inner conductor with an insulator and encasing 24 the insulator with an outer conductor as well as the optional step of jacketing 25 the outer conductor with an outer insulator. The some or all of the steps 21 to 25 may or may not happen at the same time as the cable comes together.

In the step of providing 21 a filament, a filament made of a second electroconductive material is provided. The second electroconductive material comprises or, in particular, is a superconductive material. Either only one filament or a plurality of filaments, i.e., two or more filaments, may be provided. The filaments of the plurality of filaments may be made of different second electroconductive materials comprising different superconductive materials. Further diameter of one or more or each of the filaments may be different from the remaining filaments.

In the step of surrounding 22 the filament with a mantle, the filament or the plurality of filaments are surrounded with a mantle or matrix made of a third electroconductive material to form an inner conductor. The third electroconductive material is a “non-superconductive” material.

In the step of sheathing 23 the inner conductor, the inner conductor is sheathed or coated with an insulator. The insulator is made of any dielectric material.

In the step of encasing 24 the insulator, the insulator is encased with an outer conductor made of a first electroconductive material. The first electroconductive material is a “non-superconductive” material. The first and the third electroconductive material may be the same material or different materials.

In the optional step of jacketing 25 the outer conductor, the outer conductor is jacketed or coated with an outer insulator. The outer insulator is made of any dielectric material.

The coaxial cable manufactured by the method according to FIG. 3 provides for the same advantages as the coaxial cables of FIG. 1 and FIGS. 2a and 2b as described above.

1. A coaxial cable comprising,
an inner conductor;
an outer conductor made of a first electroconductive material;
and an insulator provided between the inner conductor and the outer conductor,
wherein the inner conductor comprises:
a filament made of a second electroconductive material; and
a mantle made of a third electroconductive material surrounding the filament, and
wherein the filament, in particular the second electroconductive material, comprises a superconductive material.

2. The coaxial cable according to claim 1,
wherein the first electroconductive material comprises Copper, Cu, Copper alloy, stainless steel, silver plated stainless steel or Tungsten, W, or a combination thereof.

3. The coaxial cable according to claim 1,
wherein the third electroconductive material comprises Copper, Cu, Copper alloy, stainless steel, silver plated stainless steel or Tungsten, W, or a combination thereof.

4. The coaxial cable according to claim 1,
wherein the first electroconductive material and the third electroconductive material are the same or different.

5. The coaxial cable according to claim 1,
wherein the filament comprises two or more layers of second electroconductive materials comprising superconductive materials.

6. The coaxial cable according to claim 1,
wherein the superconductive material comprises a Niobium alloy, in particular, Niobium-Titanium, NbTi, Niobium-Tantalum, NbTa, Niobium-Tin, Nb₃Sn, or a combination thereof.

7. The coaxial cable according to claim 1,
wherein a diameter of the filament is between 1% and 95% of the diameter of the inner conductor.

8. The coaxial cable according to claim 1, further comprising:
an outer insulator surrounding the outer conductor.

9. The coaxial cable according to claim 1,
wherein the inner conductor comprises only one filament surrounded by the mantle.

10. The coaxial cable according to claim 1,
wherein the inner conductor comprises a plurality of filaments surrounded by the mantle.

11. The coaxial cable according to claim 10,
wherein at least two filaments of the plurality of filaments are made of different second electroconductive materials comprising superconductive materials.

12. A method of manufacturing a coaxial cable, comprising:
providing a filament made of a second electroconductive material, wherein the second electroconductive material comprises a superconductive material;
surrounding the filament with a mantle made of a third electroconductive material to form an inner conductor;
sheathing the inner conductor with an insulator; and
encasing the insulator with an outer conductor made of a first electroconductive material.

13. The method according to claim 12,
wherein in the step of providing the filament, only one filament or a plurality of filaments is provided, and
wherein in the step of surrounding the filament with a mantle, the only one filament or the plurality of filaments is surrounded with the mantle.

14. A method of using the coaxial cable of claim 1 in a quantum computer at a quantum processing unit (QPU) of the quantum computer comprising, using the coaxial cable to provide transmission lines for signals to qubits.
